(19) United States
(12) Patent Application Publication
(10) Pub. No.: US 2021/0097892 A1
(43) Pub. Date: Apr. 1, 2021

(54) REMOTE-DEMONSTRATION UNIT AND SYSTEM

(71) Applicant: Apple Inc., Cupertino, CA (US)

(72) Inventors: Lance W. BOETTCHER, Sunnyvale, CA (US); Dawn M. GULINO, Campbell, CA (US); Kenneth H. LEUNG, San Jose, CA (US); Philip T. WILLIAMS, Sunnyvale, CA (US); Carthi Keyan SHANMUGANATHAN, Sunnyvale, CA (US); Matthew S. HENDERSON, San Jose, CA (US); Lance D. WILLIAMS, Cupertino, CA (US)

(21) Appl. No.: 16/587,861

(22) Filed: Sep. 30, 2019

(51) Int. Cl. G09B 25/00; B65D 25/10; H04N 5/225; H04N 7/18

(52) U.S. Cl. CPC G09B 25/00; H04N 7/185; H04N 5/2256; B65D 25/10

(57) ABSTRACT

A remote-demonstration system for demonstrating products to customers from a remote location. The remote-demonstration system may include a space for demonstrating a variety of products, lighting for illuminating the products and/or the demonstration space, and a device for capturing video of the products that may be sent to customers as part of a live remote product demonstration. The remote-demonstration system may include a product-display tray on which products may be displayed side-by-side or layered one above the other. The remote-demonstration system may provide a consistent, company-branded visual experience to customers viewing the demonstration by, for example, showing the products being demonstrated in a clean, visually-appealing environment.

### FIELD

The described embodiments relate generally to remote-demonstration units and remote-demonstration systems. More particularly, the embodiments relate to remote-demonstration units and remote-demonstration systems for remotely demonstrating products to customers.

### BACKGROUND

Remote customer-assistance systems may allow customers to contact and interact with customer service employees at a remote location (e.g., at a call center). Such remote customer-assistance systems may be convenient for customers, as they may allow customers to ask questions and receive help from employees without having to travel to a particular location (e.g., a retail store). These systems may use, for example, voice communication over a telephone connection to facilitate interaction between employees and customers.

### SUMMARY

Various embodiments are disclosed that relate to remote-demonstration units and remote-demonstration systems for remotely demonstrating products to customers in a fluid, visually-appealing manner. For example, embodiments include a remote-demonstration unit that may include a housing that defines a product-demonstration space. A product-display tray may be disposed within the product-demonstration space at an oblique angle relative to a bottom of the housing, and the product-display tray may include product-support features for supporting products on the product-display tray in different spaced-apart layers. The remote-demonstration unit may also include a light system for illuminating the product-demonstration space. An image-capture device may be coupled to the housing and the image-capture device may include an image-capture lens that is directed toward the product-demonstration space.

Embodiments also include a remote-demonstration unit that may include a housing defining a product-demonstration space. A translucent product-display tray may be disposed within the product-demonstration space and may be used for displaying products. Light-emissive panels may be disposed at the sides of and beneath the product-display tray such that light produced by the light-emissive panels passes through, is diffused by, and illuminates the product-display tray. The remote-demonstration unit may also include an image-capture device for capturing video of displayed products.

Embodiments also include a remote-demonstration system that may include a housing defining a product-demonstration space, and a product-display tray may be disposed within the product-demonstration space. A consumer electronic device may be disposed on the product-display tray, and may be disposed in a pre-defined position on the product-display tray. The remote-demonstration system may also include a light system that is configured to illuminate the product-display tray and the consumer electronic device. The remote-demonstration system may also include an image-capture device that includes an image-capture lens configured to capture video of a user's manipulation of the consumer electronic device. The video captured by the image-capture device may be sent in real time to a remote customer device over a network, and the framing of the video may be adjusted to pre-defined extents based on the device type of the consumer electronic device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of a remote-demonstration unit.

FIG. 2A shows a front view of the remote-demonstration unit of FIG. 1 with a product being demonstrated by a user.

FIG. 2B shows an output image of the remote-demonstration unit of FIG. 2A.

FIG. 3 shows an exploded perspective view of the remote-demonstration unit of FIG.

FIG. 4 shows another exploded perspective view of the remote-demonstration unit of FIG. 1.

FIG. 5 shows a cross-sectional view taken along line 5-5′ of FIG. 2A.

FIG. 6 shows enlarged portion 6′ of FIG. 5.

FIG. 7 shows a cross-sectional view taken along line 7-7′ of FIG. 2A.

FIG. 8 shows enlarged portion 8′ of FIG. 7.

FIG. 9A shows a product-display tray of the remote demonstration unit of FIG. 1, with products.

FIG. 9B shows an output image of the remote demonstration unit of FIG. 1 including the product-display tray of FIG. 9A, with a product being demonstrated by a user.

FIG. 9C shows an output image of the remote demonstration unit of FIG. 1 including the product-display tray of FIG. 9A, with a product being demonstrated by a user.

FIG. 9D shows an output image of the remote demonstration unit of FIG. 1 including the product-display tray of FIG. 9A, with a product being demonstrated by a user.

FIG. 10A shows a product-display tray of the remote demonstration unit of FIG. 1, with a different product arrangement.

FIG. 10B shows a cross-sectional view taken along line 10B′-10B′ of FIG. 10A.

FIG. 10C shows an output image of the remote demonstration unit of FIG. 1 including the product-display tray of FIG. 10A, with a product being demonstrated by a user.

FIG. 11A shows a product-display tray of the remote demonstration unit of FIG. 1, with a different product arrangement.

FIG. 11B shows a cross-sectional view taken along line 11B′-11B′ of FIG. 11A.

FIG. 12 shows a perspective view of the remote-demonstration unit of FIG. 1, with the product arrangement of FIG. 10A.

FIG. 13 shows a front view of the remote-demonstration unit of FIG. 12.

FIG. 14 shows a perspective view of the remote-demonstration unit of FIG. 1, with a different product arrangement and with the image-capture assembly removed.

FIG. 15 shows a front view of the remote-demonstration unit of FIG. 14.

FIG. 16 shows a perspective view of an image-capture assembly of the remote demonstration unit of FIG. 1.

FIG. 17 shows a rear view of the image-capture assembly of FIG. 16.

FIG. 18 shows an explodes of the image-capture assembly of FIG. 16.

FIG. 19 shows a perspective view of an image-capture assembly of the remote demonstration unit.

FIG. 20 shows a partial sectional side view of the remote-demonstration unit of FIG. 1 in a first state.

FIG. 21 shows a partial sectional side view of the remote-demonstration unit of FIG. 1 in a second state.

FIG. 22 shows a partial sectional side view of the remote-demonstration unit of FIG. 1 in a third state,

FIG. 23 shows a perspective view of the remote-demonstration unit of FIG. 1 with the image-capture assembly in a different configuration.

FIG. 24 shows a partial sectional side view of the remote-demonstration unit of FIG. 23.

FIG. 25 shows a side view of the housing of the remote-demonstration unit of FIG. 1.

FIG. 26 shows a schematic block diagram of an exemplary network including the remote-demonstration unit of FIG. 1.

FIG. 27 shows a schematic block diagram of an exemplary computer system in which embodiments may be implemented.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Some retailers may afford customers a personalized user experience by, for example, allowing customers to interact with employees who are knowledgeable about the products that they sell. In an in-store environment, the store's employees may, for example, help customers shop for and select products, make product recommendations, demonstrate products, answer customer questions, or the like. Physical retail stores may also present retailers with an opportunity to craft a unique retail experience for customers by, for example, creating a particular visual appearance or impression within the retail space, selecting how customers view, interact with, and experience products, and tailoring the manner in which customers receive assistance from employees.

Accordingly, customers who are unable or disinclined to visit a physical retail store (e.g., customers who do not live near a store, have disabilities that limit their mobility, or prefer to shop online) may not receive the personalized and unique retail experience as might be received by a customer at a physical retail store. For example, a customer who is shopping for products online may have questions about the products, or may wish to compare several product options. While a retail website may provide images, prerecorded videos, and descriptions of the products, for example, a customer may have specific questions or concerns about the products and may prefer to discuss them with an employee before making a purchase. Similarly, a customer who has already purchased a product may need or prefer assistance with, for example, setting up the product, troubleshooting issues with the product, or learning more about the functionality and uses of the product.

Permitting customers to remotely interact with employees (e.g., at a call center) may provide a more personalized retail experience to remote customers, for example, by allowing them to ask specific questions about products, to discuss product options with employees, or to receive assistance with products in real time. In this manner, such a system may be conducive to increased customer engagement with employees and may lead to greater customer satisfaction. However, while it may be possible for employees to remotely assist customers using methods of remote customer assistance such as voice communication (e.g., telephone or the like) or text communication (e.g., messaging, email, or the like), certain aspects of some products may be difficult to capture via such methods or may be more effectively conveyed through a live visual demonstration of the product.

Remote-demonstration systems may allow employees to remotely share with customers, for example, live video of certain elements of a product (e.g., a screencast of the graphical user interface of an electronic device). However, by sharing only certain aspects of the product, a customer may not develop a complete understanding of the product or how to use the product. This may be particularly true for products that include both hardware and software components (e.g., smartphones, smart watches, tablet computers, personal computers, or the like), where a customer may better understand the product and how to use the product if the employee demonstrates both the hardware and software components of the product. Similarly, a demonstration in which an employee interacts with the physical product may help a customer to better understand the experience of using the product, since a user's interaction with the physical product may have a significant effect on the user's experience.

As with physical retail stores, a system for remotely conducting live visual demonstrations of products may also present retailers with an opportunity to craft a unique experience for customers, that customers may associate with the retailer or its products. For example, a retailer may choose to present products in a setting that creates a particular visual appearance or impression that is consistent with the retailer's desired visual branding. Likewise, retailers may select the manner in which remote customers interact with and receive assistance from employees in order to create a fluid, engaging customer service experience that reflects the retailer's desired brand experience. As such, a live visual demonstration of a physical product that establishes a personalized, visually pleasing interaction between a customer, an employee, and the products may improve the customer's overall retail experience and satisfaction.

The present disclosure relates to remote-demonstration units, which may be part of remote demonstration systems, and which may be used, for example, to demonstrate products to customers from a remote location (e.g., a remote service center or the like). The remote demonstration units may be self-contained units including, for example, a space for demonstrating a variety of products, lighting for illuminating the products and/or the product-demonstration space, and a device for capturing video of the products that may be sent to customers in real time (e.g., over the internet) as part of a live, remote product demonstration. The remote-demonstration units may provide a consistent visual experience to customers viewing the demonstration by, for example, showing the products being demonstrated in a clean, visually-appealing environment, with consistent product positioning, illumination, and framing. The remote-demonstration units may also provide a personalized user experience to customers by allowing the customers to interact (e.g., by voice or message) with the employees demonstrating the products.

Embodiments may include a housing defining a space for demonstrating products and a product-display tray disposed within the product-demonstration space. One or more products may be arranged, for example, side-by-side on the product-display tray such that several products may be displayed and demonstrated simultaneously. Several products may also be displayed and demonstrated sequentially, for example, by layering the products one above the other on the product-display tray. The product-display tray may be modular and may be easily replaced or reconfigured, for example, to accommodate new types of products or a new retail strategy. The remote-demonstration unit may also include a light system for illuminating the product-demonstration space as well as an image-capture device for capturing video of the demonstrated products and/or the employee demonstrating the products. The light system and/or the image-capture device may be adjusted based on the product that the employee is demonstrating, for example, to achieve a proper exposure and/or to frame the product in a visually-pleasing way. In this manner, the remote-demonstration unit may produce a consistent visual experience for a variety of different types of products.

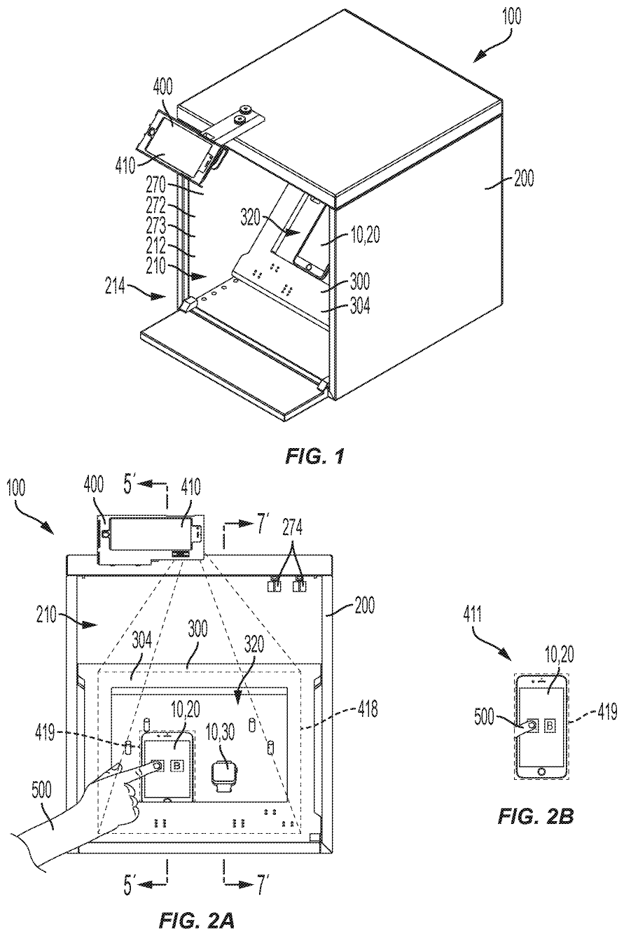

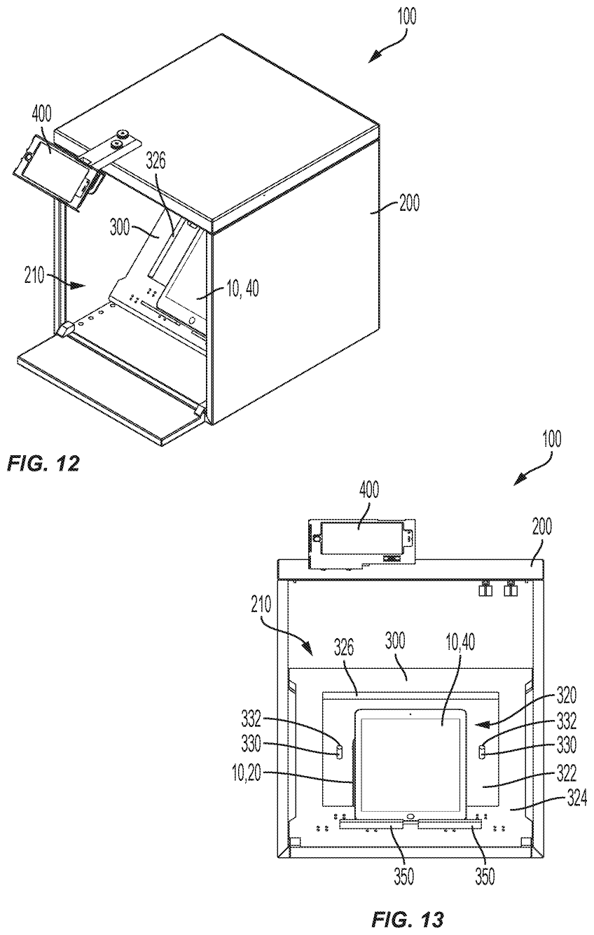

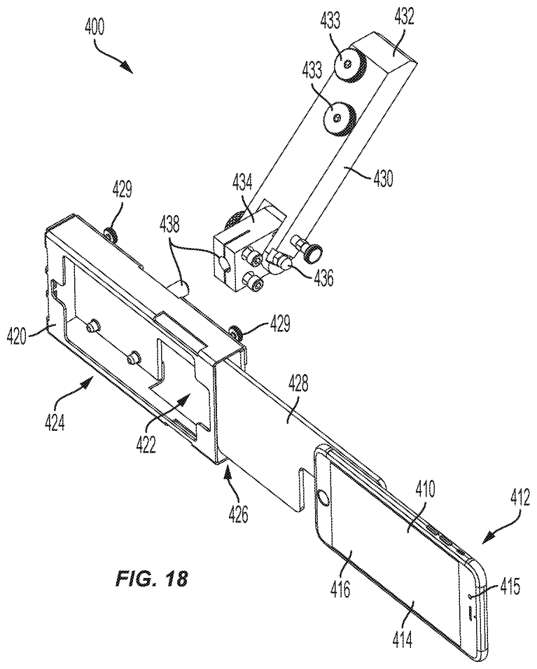

These and other embodiments are discussed below with reference to FIGS. 1-27. However, those skilled in the art will readily appreciate that the detailed description given herein with respect to these figures is for explanatory purposes only and should not be construed as limiting.

FIGS. 1 and 2A show a remote-demonstration unit 100 according to some embodiments. FIG. 1 is a perspective view of remote-demonstration unit 100, and FIG. 2A is a front view of remote-demonstration unit 100 and a user 500 (e.g., a customer-service employee of remote-demonstration unit 100. As shown, remote-demonstration unit 100 may include a housing 200, a product-display tray 300, and an image-capture assembly 400.

Product-display tray 300 may be positioned within a product-demonstration space 210 of housing 200, and image-capture assembly 400 may be attached to housing 200 (e.g., above product-demonstration tray 300). One or more products 10 (e.g., consumer electronic devices) may be arranged in various configurations on product-demonstration tray 300. During a remote-demonstration session, live video of portions of product-demonstration space 210 (e.g., displayed products 10) may be captured by an image-capture device 410 (e.g., a camera) of image-capture assembly 400 and may be sent in real-time to a remote customer. Further, products 10 may be accessible to user 500 such that user 500 may manipulate products 10 during a remote-demonstration session. As shown in FIG. 2A, for example, user 500 may reach through an opening 214 in housing 200 in order to manipulate products 10 that are displayed on product-demonstration tray 300. As shown in FIG. 2B, for example, an output image 411 (e.g., a video) of image-capture device 410 may include images of products 10 as well as images of user 500 manipulating products 10. In this manner, a remote customer may watch user 500 demonstrate and interact with products 10, which as discussed above may help a remote customer to better understand products 10 and the experience of using products 10.

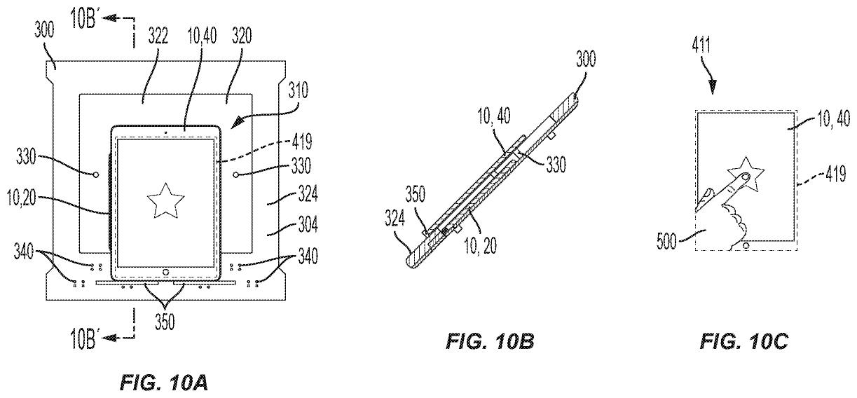

Remote-demonstration unit 100 may also include features that facilitate consistent, fluid, and visually-pleasing remote-demonstration sessions. For example, in some embodiments, two or more products 10 may be disposed side-by-side on product-demonstration tray 300 (see, e.g., FIG. 2A). In this manner, several products 10 may be demonstrated individually without need for user 500 to move or rearrange products 10 in between the demonstration of each individual product 10. Instead, output image 411 may show only the product 10 currently being demonstrated, and may omit other products 10 on product-demonstration tray 300. Such flexibility in output may reduce the amount of lag time between demonstrations, which may increase efficiency and/or create a more fluid experience for customers. With several products 10 disposed side-by-side on product-display tray 300, the several products 10 may also be demonstrated simultaneously, for example, to show how products 10 may interact with one another. Further, two or more products 10 may be layered one above the other on product-demonstration tray 300 (see, e.g., FIG. 10A), which may allow product-demonstration tray 300 to receive a wider variety of products 10 while maintaining a compact footprint. In some embodiments, product-demonstration tray 300 itself may be easily removable and replaceable, which may further increase the modularity and flexibility of remote-demonstration unit 100.

Housing 200 may include a light system 270 that illuminates products 10 and/or product-demonstration tray 300 in a consistent, visually-appealing manner without shadows from products 10 being visible to image-capture device 410. Further, in some embodiments, product-demonstration tray 300 is translucent such that when it is illuminated by light system 270, products 10 displayed on product-demonstration tray 300 appear to be disposed in a clean and luminous environment. To produce consistent illumination of products 10, certain parameters of light system 270 (e.g., light intensity and/or light coloring) may be adjusted, for example, according to pre-set parameters corresponding to the type of products 10 being demonstrated or to compensate for varying ambient lighting conditions.

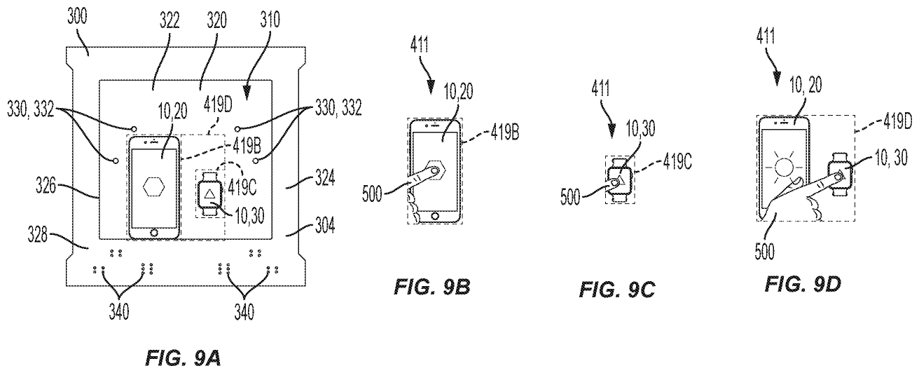

Further, the visual framing of images captured by image-capture device 410 may be easily adjusted to produce consistent, fluid, and visually-pleasing demonstrations of a variety of products 10. For example, image-capture device 410 may be capable of capturing images of the entirety of product-demonstration tray 300, but output image 411 may be less than the entirety of product-demonstration tray 300. As shown in FIG. 2A, for example, image-capture device 410 may have a field of view 418 (e.g., the maximum observable area of image-capture device 410) that captures the majority of product-demonstration tray 300. As shown in FIG. 2B however, an output image 411 (defined by image boundary 419) of image-capture device 410 may be only a portion of field of view 418. Output image 411 may be framed to include images of product 10 and the area immediately adjacent to product 10 (e.g., as shown in FIG. 2B). However, output image 411 may also be framed to include images of multiple products together or only a portion (e.g., the display screen) of a product 10 (examples are shown in FIG. 9D and FIG. 10C, discussed in more detail elsewhere herein). As with light system 270, the visual framing of images captured by image-capture device 410 may be adjusted based on pre-set parameters corresponding to the type of products 10 being demonstrated by user 500, which may also facilitate consistent, efficient, and visually-pleasing remote-demonstration sessions.

As mentioned above, housing 200 may include product-demonstration space 210, which may be defined by interior surfaces 212. Product-display tray 300 may be disposed in product-demonstration space 210, and products 10 may be displayed on product-display tray 300. A user of remote-demonstration unit 100 (e.g., an employee 500 who is demonstrating products 10) may access product-demonstration space 210, product-display tray 300, and products 10 through an opening 214 of housing 200. In some embodiments, opening 214 defines a front side of housing 200.

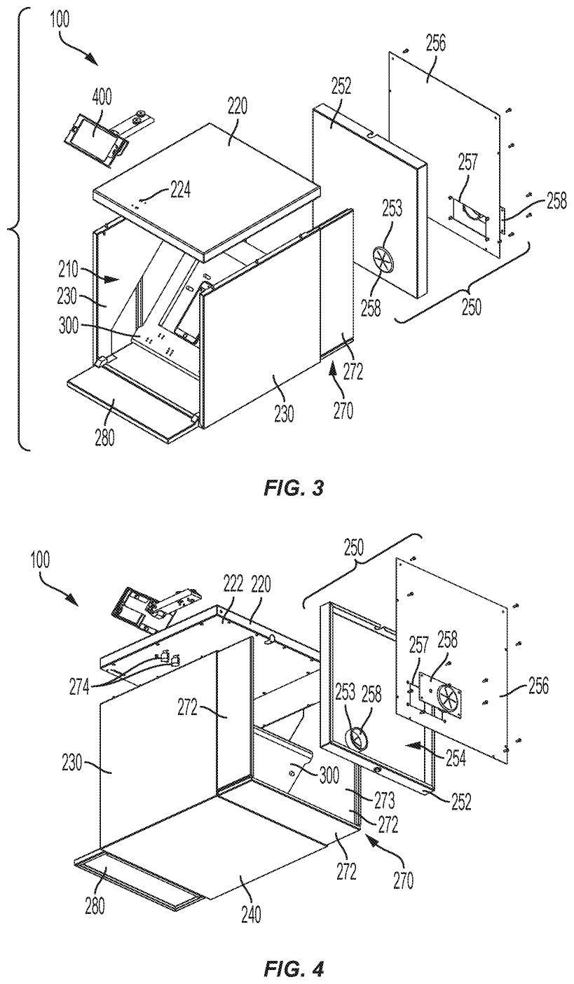

FIGS. 3 and 4 show exploded views of remote-demonstration unit 100 according to some embodiments. In some embodiments, housing 200 includes a top panel 220, side panels 230, a bottom panel 240, and an electronics enclosure 250, which together form the general shape of housing 200. As shown in FIGS. 1 and 2A, in some embodiments, housing 200 may have a generally cubic shape. However, housing 200 may have other shapes as well which are not shown in the figures such as, for example, rectangular prismatic, cylindrical, spherical, or frustoconical. In some embodiments, each of top panel 220, side panels 230, bottom panel 240, and electronics enclosure 250 may be removably coupled together. In some embodiments, one or more of top panel 220, side panels 230, bottom panel 240, and electronics enclosure 250 may be integrally formed together.

Housing 200 may be sized such that it may be placed on a desk, for example, or other elevated support surface such as a table, counter, stand or the like. The compact size of housing 200 may allow remote-demonstration unit 100 to be used in typical office setting, for example, at a call center or other customer-assistance facility without requiring substantial space or infrastructure to accommodate remote-demonstration unit 100. In this manner, remote-demonstration unit 100 may be, for example, shipped to and implemented in existing customer-assistance facilities without substantial modifications to the facilities. In some embodiments, remote-demonstration unit 100 is a desktop unit. In some embodiments, the footprint of remote-demonstration unit 100 (e.g., the area of bottom panel 240) is less than approximately 10 square feet. In some embodiments, the footprint of remote-demonstration unit 100 is less than approximately 4 square feet. In some embodiments, the footprint of remote-demonstration unit 100 is approximately 2 square feet.

With reference to FIGS. 1-4, electronics enclosure 250 may define a rear of housing 200. In some embodiments, electronics enclosure 250 includes a base 252 and a cover 256 that, when coupled together, form an enclosed space 254. Enclosed space 254 may be accessed, for example, by removing cover 256. Enclosed space 254 may be used, for example, to enclose, organize, and/or hide elements of remote-demonstration unit 100 that may not need to be readily accessible by the user such as, for example, wiring, electronics, power converters, or the like. Cover 256 of electronics enclosure 250 may include a hole 257 through which cables (e.g., data, power, or the like) may be fed from the exterior of housing 200 into enclosed space 254. Likewise, base 252 of electronics enclosure 250 may include a hole 253 through which cables may be fed from enclosed space 254 into product-demonstration space 210. In some embodiments, each of holes 253, 257 includes a grommet 258 that may protect and guide the cables and may reduce the amount of dust or debris, for example, that enters electronics enclosure 250.

In some embodiments, electronics enclosure 250 is easily removed from other portions of housing 200. In this manner, electronics enclosure 250 may be used to increase the modularity of remote-demonstration unit 100. Since, as mentioned above, electronics enclosure 250 may contain various electronics, wiring, or other components, the removability of electronics enclosure 250 may facilitate repair and maintenance of such components. For example, if there are issues with the components in electronics enclosure 250, the electronics enclosure 250 with damaged components may be remove and replaced with another electronics enclosure 250 while the electronics enclosure 250 with damaged components is repaired. Similarly, if it is necessary to update or replace components housed in electronics enclosure 250 (e.g., to accommodate a new line of products), an electronics enclosure 250 with updated components may be sent to the customer assistance facility pre-assembled and easily connectable to the rest of the remote-demonstration unit 100, thereby minimizing the amount of time and effort that must be expended by employees at the customer assistance facility to update remote-demonstration unit 100.

With reference to FIGS. 3 and 4, housing 200 may include light system 270 that may be used, for example, to illuminate product-demonstration space 210, product-display tray 300, and/or products 10. In some embodiments, light system 270 includes a light-emissive panel 272. Light-emissive panel 272 may be, for example, a substantially flat panel that includes a light or an array of lights for producing light (e.g., visible light). Light-emissive panel 272 may include one or more light-emitting diodes (“LEDs”), incandescent lights, fluorescent lights, or the like. In some embodiments, light-emissive panel 272 produces white light.

In some embodiments, light-emissive panel 272 includes a panel surface 273 through which light is emitted into product-demonstration space 210. Panel surface 273 may, for example, diffuse, scatter, or soften light that is produced by the lights in light-emissive panel 272. As discussed in further detail below, diffused light may help to reduce shadowing in product-demonstration space 210, which may help to create a uniform, visually-pleasing appearance of products 10 in product-demonstration space 210.

In some embodiments, light system 270 includes three light-emissive panels 272 disposed to illuminate product-demonstration space 210, product-display tray 300, and/or products 10. As shown in FIGS. 3 and 4, for example, a light-emissive panel 272 is disposed adjacent to and aligned parallel with bottom panel 240 and a light-emissive panel 272 is disposed adjacent to and aligned parallel with each of side panels 230. In some embodiments, light system 270 may include one, two, three, four, or more light-emissive panels 272 arranged to illuminate product-demonstration space 210, product-display tray 300, and/or products 10. In some embodiments, light-emissive panels 272 may be decoupled from other portions of housing 200 such that they may be removable and replaceable. In some embodiments, light-emissive panels 272 are integrally formed with other portions of housing 200 such as, for example, top panel 220, side panels 230, bottom panel 240, and/or electronics enclosure 250. In some embodiments, one or more light-emissive panels 272 are integrally formed with product-display tray 300.

As mentioned above, a retailer may wish to craft a consistent visually brand-associated experience for customers viewing a demonstration that is conducted using remote-demonstration unit 100, for example, by presenting products 10 in a clean, uniform environment. While light system 270 may produce light that facilitates such a visual impression, certain external factors such as the ambient light surrounding remote-demonstration unit 100—may make it difficult to produce a consistent visual presentation of products 10 without adjustments to light system 270, example, the space in which remote-demonstration unit 100 is being used may include various types of interior lighting (e.g., incandescent, fluorescent, or LED), which may produce varying intensities and colors of ambient light. Similarly, the remote-demonstration unit's proximity to sources of natural light (e.g., via windows or skylights) may also produce different intensities and colors of ambient light depending on the time of day and weather, for example. Accordingly, and as discussed in further detail below, the intensity and color of light produced by light system 270 may be manually or automatically adjusted to compensate for varying ambient lighting in order to produce a consistent visual presentation of products 10.

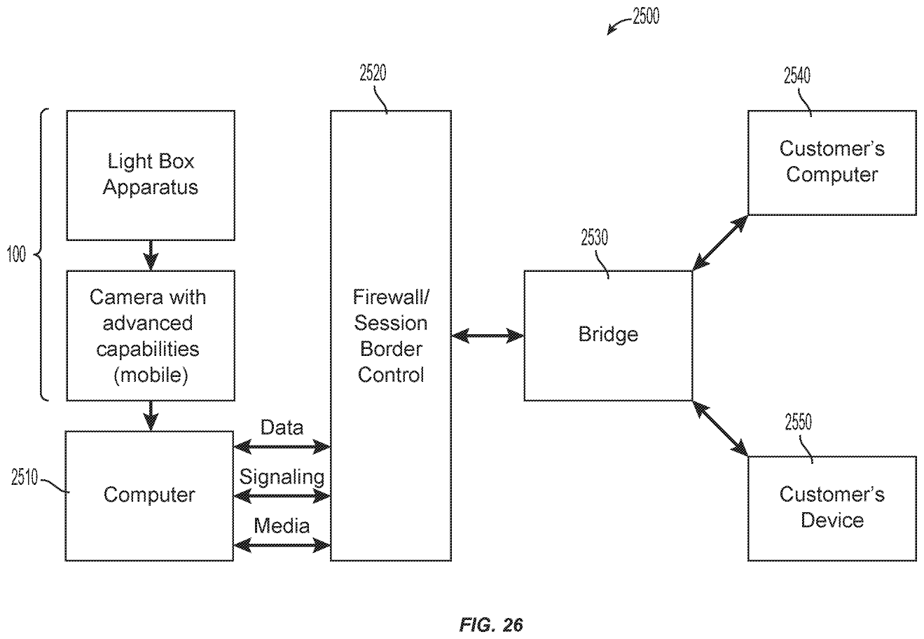

In some embodiments, light system 270 may include lighting controls 274. As shown in FIGS. 2A and 4, for example, lighting controls 274 may be knobs that are disposed on a bottom surface 222 of top panel 220 of housing 200. Lighting controls 274 may be used to control the state of light-emissive panels 272 (i.e., on or off), the intensity of light produced by light-emissive panels 272 (e.g., brightness), or the color of light produced by light-emissive panels 272 (e.g., color temperature). In some embodiments, remote-demonstration unit 100 may include a control unit 2510 (see, e.g., FIG. 26) that controls certain operations of remote-demonstration unit 100. In some embodiments, the state of light-emissive panels 272, the intensity of light produced by light-emissive panels 272, and/or the color of light produced by light-emissive panels 272 is automatically controlled by control unit 2510, as discussed in further detail below. In some embodiments, each of the light-emissive panels 272 of light system 270 may be individually adjusted.

Certain products 10 (e.g., electronic devices) may include reflective surfaces (e.g., glass) that may reflect light produced by light-emissive panels 272. In some cases, light that reflects off of reflective surfaces of products 10 may be captured by an image-capture device 410 (discussed in detail below) and, if the reflected light is concentrated and/or of sufficient intensity, may produce a glare that is captured by image-capture device 410. Such a glare may obscure certain portions of product 10 or otherwise create an inconsistent or unpleasing visual appearance of product 10. Accordingly, in some embodiments, certain portions of interior surface 212 of housing 200 include no light-emissive panels 272 in order to reduce the amount of intense reflected light that is captured by image-capture device 410. Further, certain portions of interior surface 212 may include darkly-colored and/or non-glossy materials (e.g., matte black fabric, paint, or other covering), which may help to reduce the amount of intense reflected light that is captured by image-capture device 410.

For example, as shown in FIGS. 1 and 2A, image-capture device 410 may be coupled to top panel 220 of housing 200 and, thus, may be disposed generally above products 10. Thus, light that reflects off of products 10 in a generally upward direction may be captured by image-capture device 410 and, if the reflected light is concentrated and/or of sufficient intensity, may produce a glare. Accordingly, in some embodiments, no light-emissive panels 272 are disposed adjacent to top panel 220 of housing 200 (i.e., there is no light source directly above product demonstration space 210), thereby reducing the amount of light radiating in a generally downward direction, and thereby reducing the amount of light that reflects off of products 10 in a generally upward direction. Further, in some embodiments, bottom surface 222 of top panel 220 may include a darkly-colored and/or non-glossy material (e.g., a matte-black surface) which may further help to reduce the amount of light that reflects off of products 10 in a generally upward direction.

As shown in FIGS. 1 and 2A, for example, product-display tray 300 may be disposed in product-demonstration space 210 and may be used to support products 10 during a demonstration. Product-display tray 300 may be used to display a variety of different kinds of products 10 of various types, shapes, and sizes. Products 10 may be retail products such as, for example, consumer electronic devices. Products 10 may be, for example, cell phones, smartphones, media players, smart watches, tablet computers, personal computers, laptop computers, or the like.

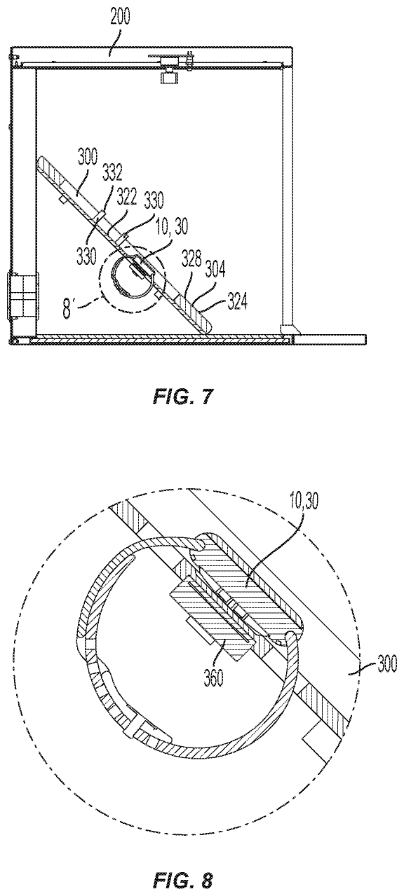

Products 10 may be disposed on product-display tray 300 (see, e.g., product 20 in FIGS. 1 and 2A) and may extend partially through product-display tray 300 (see, e.g., product 30 in FIGS. 2A and 7). As mentioned above, in some embodiments, product-display tray 300 is easily removed from housing 200 and may be replaceable and/or reconfigurable. For example, if product-display tray 300 must be replaced or reconfigured to accommodate a new line of products or to accommodate a new retail strategy, a new product-display tray 300 that is configured for the new line of products and/or strategy may be sent to the customer assistance facility pre-assembled and easily installable, thereby minimizing the amount of time and effort that must be expended by employees at the customer assistance facility to update the remote-demonstration unit 100.

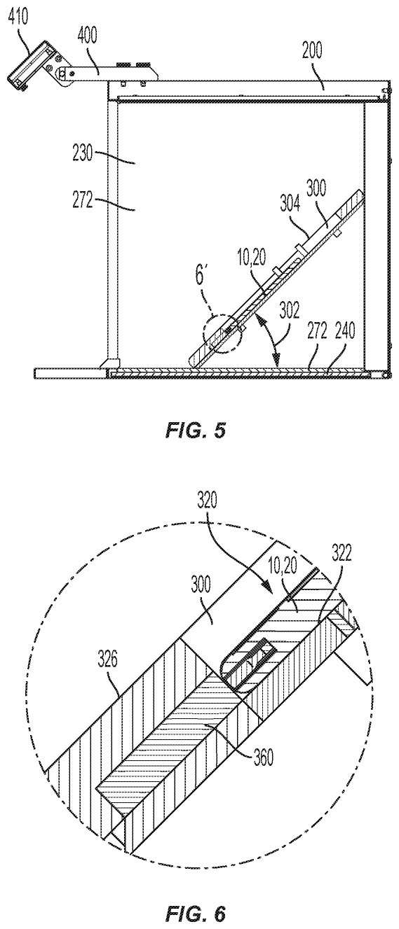

Product-display tray 300 may be positioned at an angle 302 relative to bottom panel 240 of housing 200 (see FIG. 5). In this manner, product-display tray 300 may be used to support products 10 at an angle that makes it easy for a user of remote-demonstration unit 100 to reach, view, and manipulate products 10 during a demonstration. In some embodiments, angle 302 is oblique. In some embodiments, angle 302 is between approximately 30 and 60 degrees. In some embodiments, angle 302 is approximately 45 degrees. In some embodiments, angle 302 is adjustable (e.g., by moving product display tray 300 within product display space 210), for example, to accommodate different types of products 10 or display arrangements.

In some embodiments, product-display tray 300 is coupled to housing 200 using, for example, one or more screw, bolts, clamps, latches, pins, or the like. In some embodiments, product-display tray 300 is held in position by gravity and/or mechanical stops.

In some embodiments, product-display tray 300 is translucent, which is to say that some light is permitted to pass through product-display tray 300. In some embodiments, product-display tray 300 may have a transparency of approximately 30 to 70 percent. In some embodiments, light passing through product-display tray 300 may be diffused, scattered, softened, or the like, which may help to create a uniform, visually-appealing demonstration environment for products 10. For example, in some embodiments, product-display tray 300 is translucent and white in color. Light produced by light-emissive panels 272 may also be white and may pass through product-display tray 300. Since the light produced by light-emissive panels 272 is diffused, scattered, softened, or the like as it passes through product-display tray 300, product-display tray 300 may be illuminated and radiate a soft, white light through its top surface 304. This light illuminating through top surface 304 may soften or eliminate shadows of products 10 on top surface 304 that might otherwise be formed as a consequence of other light sources (e.g., side light-emissive panels 272 or ambient light sources). Accordingly, from a vantage that is substantially normal (perpendicular) to top surface 304 (e.g., from the perspective of image-capture device 410), products 10 that are disposed on product-display tray 300 may appear to be disposed in a clean, white, and luminous environment,

As mentioned above, in some embodiments, three light-emissive panels 272 are disposed to illuminate product-demonstration space 210, product-display tray 300, and/or products 10: one light-emissive panel 272 is disposed adjacent to (or, in some embodiments, formed as part of) bottom panel 240, and one light-emissive panel 272 is disposed adjacent to (or, in some embodiments, formed as part of) each of side panels 230 (see, e.g., FIG. 4). As shown in FIG. 5, for example, product-display tray 300 may be disposed vertically above the light-emissive panel 272 that is disposed adjacent to bottom panel 240. Thus, light produced by the bottom light-emissive panel 272, for example, may radiate in a generally upward direction, where it is diffused, scattered, softened, or the like as it passes through product-display tray 300, thereby illuminating product display tray 300 and/or products 10. Similarly, light produced by the light-emissive panels 272 that are disposed adjacent to side panels 230, for example, may radiate in a generally horizontal direction and may further illuminate product display tray 300 and/or products 10. Accordingly, from the perspective of image-capture device 410, products 10 that are disposed on product-display tray 300 may be uniformly lit without shadows from products 10 being visible to image-capture device 410, thus giving products 10 the appearance of being disposed in a clean, white, and luminous environment.

FIGS. 9A-13 show product-display tray 300 with different product arrangements and product-support features 310. For example, product-display tray 300 may include product-support features 310 for supporting products 10 on product-display tray 300. Product-support features 310 may include a recess 320 defining a first support surface 322 for supporting products 10. A frame 326 may surround recess 320 and may be raised relative to first support surface 322. In some embodiments, frame 326 defines a lower pedestal 328 for supporting products 10, which may be part of a second support surface 324 for supporting products 10 that are displaced (e.g., vertically) relative to first support surface 322. In some embodiments product-display tray 300 may include lower pedestal 328 without the rest of frame 328 surrounding recess 320.

In some embodiments, products 10 may be placed side-by-side (e.g., in recess 320) and supported by first support surface 322 and/or a side surface of lower pedestal 328 (see, e.g., FIGS. 2A and 9A). In this manner, several products 10 may be demonstrated individually or together without need for the user of the remote-demonstration unit 100 to move or rearrange products 10 in between the demonstration of each individual product 10. For demonstration of only one of products 10 on product-display tray 300, output image 411 of remote-demonstration unit 100 may be framed to only show the desired one of products 10. For example, though product-display tray 300 in FIG. 9A includes both product 20 and product 30, output image 411 of FIG. 9B includes only product 20 (and is framed along the corresponding image boundary 419B of FIG. 9), and output image 411 of FIG. 9C includes only product 30 (and is framed along the corresponding image boundary 419C of FIG. 9A). In a situation where both products 20 and 30 are desired to be demonstrated simultaneously, output image 411 may be framed to include both. For example, output image 411 of FIG. 9D includes both products 20 and 30, and is framed along the corresponding image boundary 419D of FIG. 9A,

Such flexibility in output may reduce the amount of lag time between demonstrations, which may increase efficiency and/or create a more fluid experience for customers. Similarly, with several products 10 disposed side-by-side on product-display tray 300, the several products 10 may be demonstrated simultaneously. This may, for example, allow a customer to see how several products 10 interact with one another. With reference to FIG. 9A, for example, a first product 20 (e.g., a smartphone) may be disposed at the side of a second product 30 (e.g., a smart watch). A user's manipulation of the second product 30 (e.g., pressing on the touch screen of the smart watch) may cause a visible response from the first product 20 (e.g., triggering an audible alarm to help a user locate the smartphone) without direct manipulation of the first product 20 by the user of the remote-demonstration unit.

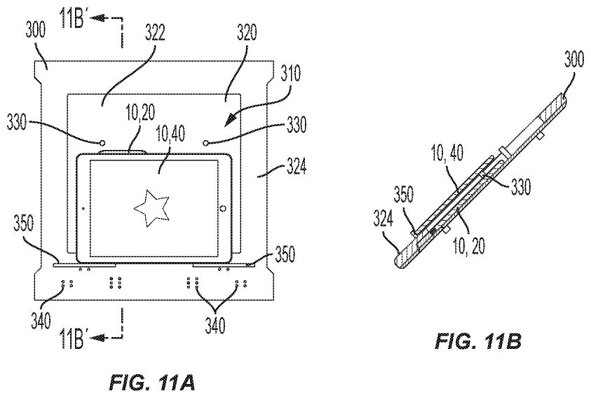

Products 10 may also be supported on product-display tray 300 in different spaced-apart layers (see, e.g., FIGS. 10A-13). By layering products 10 above one another on product-display tray 300, product-demonstration space 210 may be more efficiently utilized than if, for example, all products 10 were disposed side-by-side, thereby helping to keep remote-demonstration unit 100 more compact in size. Further, several products 10 may be demonstrated sequentially without need for the user to remove any products 10 from product-demonstration space 210. Rather, the user may simply and quickly place one product 10 above another product 10 (e,g., product 40 is placed above products 20 and 30 in FIGS. 10A-11B), which may reduce the amount of lag time between the demonstration of each product 10, thereby increasing efficiency and/or creating a more fluid experience for customers.

As shown in FIGS. 7-13, for example, product-support features 310 may be positioned to readily support products 10 in a desired and repeatable position, without the need for movable mechanisms. Such product-support features 310 may include one or more support pegs 330. Support pegs 330 may be disposed within recess 320, may extend up from first support surface 322, and may be used to support products 10 that are disposed above recess 320. In some embodiments, support pegs 330 include an upper surface 332 that may be used to support products 10. In some embodiments, upper surface 332 is raised relative to first support surface 322 at least as far as lower pedestal 328 is raised relative to first support surface 322. In some embodiments, upper surface 332 is raised relative to first support surface 322 as far as lower pedestal 328 is raised relative to first support surface 322. In some embodiments, upper surface 332 is raised relative to first support surface 322 more than lower pedestal 328 is raised relative to first support surface 322.

(00781 Product-support features 310 may also include one or more stops 350 that may be used for example, to help support products 10 that are disposed above recess 320, and/or to prevent products 10 from sliding down the inclined product-display tray 300. Stops 350 may extend from second support surface 324. In some embodiments, stops 350 are coupled to or integrally formed with product-display tray 300. In some embodiments, product-display tray 300 includes an array^{,} of holes 340 disposed in second support surface 324 for receiving stops 350. To accommodate different sizes and types of products 10, for example, the position of stops 350 may be changed by securing stops 350 to holes 340 at different positions (compare, e.g., FIGS. 10A and 11A).

As shown in FIG. 9A, a first product 20 (e.g., a smartphone) and a second product 30 (e.g., a smart watch) may be disposed side-by-side on first support surface 322 in recess 320 of product-display tray 300. As shown in FIGS. 10A, 10B, 1lA and 11B, a third product 40 (e.g., a tablet computer or the like) may be layered above first and second products 20, 30, and may be supported by second support surface 324, support pegs 330, and/or stops 350. Third product 40 may also be arranged in various orientations above first and second products 20, 30. For example, in FIGS. 10A and 10B, the upper portion of product 40 may be supported above first and second products 20, 30 by the two most central support pegs 330, and the lower portion of product 40 may be supported by second support surface 324 and stops 350. As shown in FIGS. 11A and 11B, the upper portion of product 40 may be supported above first and second products 20, 30 by the two outermost support pegs 330, and the lower portion of product 40 may be supported by second support surface 324 and stops 350. Such flexibility in the positioning and arrangement of products 10 may increase the modularity of remote-demonstration unit 100, and may allow remote-demonstration unit 100 to be capable of demonstrating a wider variety of products 10.

In some embodiments, product-support features 310 are made from the same material as product-display tray 300. Product-support features 310 may be translucent, and may diffuse, scatter, or soften light in a manner similar to that as described above with respect to product-display tray 300.

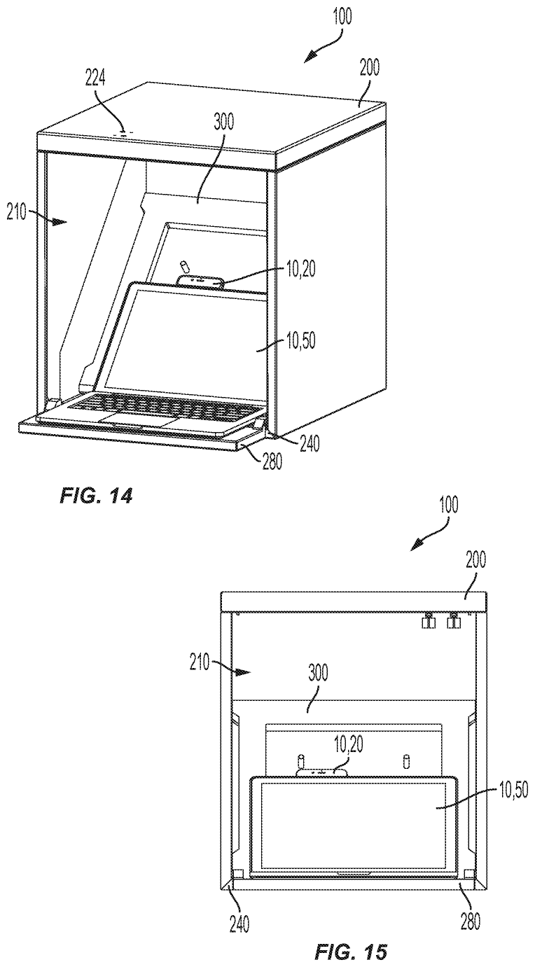

With reference to FIGS. 14 and 15, products 10 that are too large to fit on product-display tray 300 or irregularly shaped, for example, may be disposed in front of product-display tray 300. For example, a large product 50, such as a laptop computer, may be positioned in front of product-display tray 300 such that a portion of it (e.g., its screen) is disposed above product-display tray 300 within the field of view of image-capture device 400. In some embodiments, housing 200 may include a support tray 280 that is disposed adjacent to bottom panel 240 and is used to help support large product 50 by effectively extending bottom panel 240 outside of product-demonstration space 210. In some examples, large product 50 may be a laptop computer. In order to position the laptop computer for a demonstration, for example, the base portion of the laptop may be positioned on bottom panel 240 and/or support tray 280. Then, the top portion of the laptop (including its display screen) may be opened such that the top portion of the laptop is substantially parallel to and/or in contact with product-display tray 300. In this manner, product-display tray 300 may act as a positive stop and/or alignment guide for large product 50, which may allow a user setting up the demonstration of large product 50 to do so in a quick and consistent manner. Again, such flexibility in the positioning and arrangement of products 10 may increase the modularity of remote-demonstration unit 100, and may allow remote-demonstration unit 100 to be capable of demonstrating a wider variety of products.

As mentioned above, product-display tray 300 may be easily removable and replaceable, which may increase the modularity of remote-demonstration unit 100. For example, a first product-display tray 300 may include products 10 and/or product support features 310 in a first configuration, and a second product-display tray 300 may include products 10 and/or product support features 310 in a second configuration. To change from one type of product demonstration to another type of product demonstration, the user of the remote-demonstration unit 100 may quickly and easily remove the first product-display tray 300 from product-demonstration space 210 and replace it with the second product-display tray 300. Similarly, in some embodiments, two or more product-display trays 300 may be layered in product-demonstration space 210. To change from one type of product demonstration to another type of product demonstration, the user of the remote-demonstration unit 100 may quickly and easily layer the second product-display tray 300 above or in front of the first product-display tray 300 in product-demonstration space 210.

In some embodiments, product-display tray 300 includes concealed cables and/or connectors that may be used to provide power and/or data, for example, to products 10 during a demonstration. As shown in FIGS. 5-8, for example, product-display tray 300 may include one or more concealed connectors 360 that may be integrated into product-display tray 300, or may extend through a hole in product-display tray 300, such that products 10 may receive power and/or data from concealed connector 360 without such connections being visible to a customer. Concealed connectors 360 may also prevent the need to remove products 10, for example, to charge the product's batteries or to update its software. In some embodiments a concealed connector 360 may form a wired connection (e.g., concealed connector 360 may be a plug, as shown in FIG. 6), and in some embodiments a concealed connector 360 may form a wireless connection (e.g., concealed connector 360 may be an inductive charger, as shown in FIG. 8).

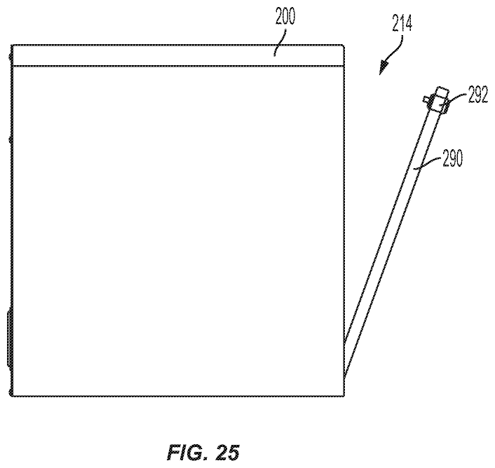

As shown in FIG. 25, in some embodiments, housing 200 includes a door 290 that, when in a closed position, may be used to cover opening 214. Door 290 may include a lock 292 that secures door 290 in the closed position, thereby preventing unauthorized access to product-demonstration space 210. Products 10 may be locked inside of housing 200 when remote-demonstration unit 100 is not in use. Since remote-demonstration unit 100 may be used in a large office setting, for example, the lockable housing may help to maintain control of and access to products 10 and remote-demonstration unit 100.

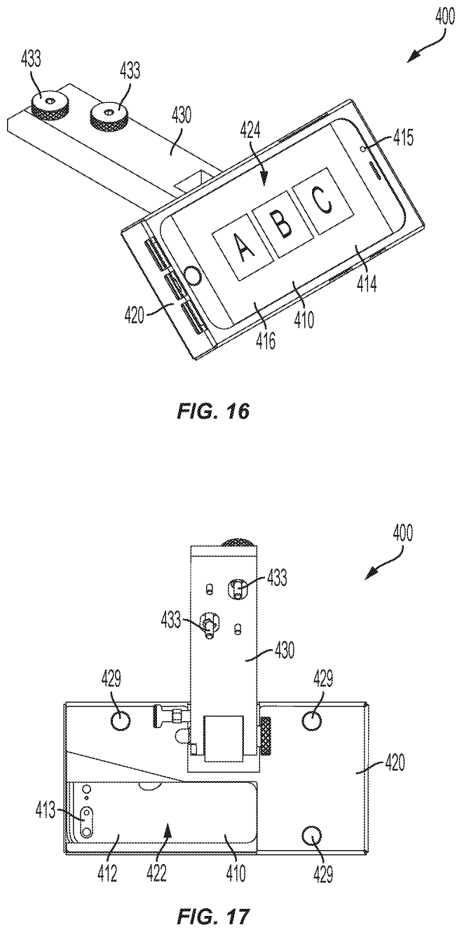

FIGS. 16-18 show image-capture assembly 400 according to some embodiments. Image-capture assembly 400 may include an image-capture device 410, a device housing 420, and an attachment arm 430.

Image-capture device 410 may be, for example, an electronic device having an image-capture lens 413 for capturing video of the products 10. In some embodiments, image-capture device 410 may be a digital camera such as, for example, a compact digital camera, a digital single-lens reflex camera (“DSLR”), a mirrorless camera, or the like. In some embodiments, image-capture device 410 may be an electronic device that includes an image-capture lens 413 but also has other features and functionality such as, for example, a smartphone. In some embodiments, image-capture device 410 may be the same product or product type as at least one of the products 10 that are being demonstrated. For example, both image-capture device 410 and a product 10 may be smartphones. In some embodiments, image-capture device 410 may include a microphone for capturing audio that the user of remote-demonstration unit 100 may use to talk to the customer in real time during a demonstration. In some embodiments, the user of remote-demonstration unit 100 may talk to the customer using a microphone (e.g., on a headset) that is separate from image-capture device 410. In some embodiments, image-capture device 410 may include a speaker for playing audio that the user of remote-demonstration unit 100 may use to hear the customer. In some embodiments, the user of remote-demonstration unit 100 may hear the customer using a speaker (e.g., on a headset) that is separate from image-capture device 410.

In some embodiments, image-capture device 410 includes a user interface 416. In some embodiments, user interface 416 includes a touch screen display for receiving user input and communicating information to the user. In some embodiments, user interface 416 includes electromechanical buttons for receiving input from a user. In some embodiments, user interface 416 includes a visual display for communicating with or displaying information to a user. In some embodiments, user interface 416 includes a combination of touch screens, electromechanical buttons, and/or visual displays. User interface 416 may display information about, for example, the customer who the user of remote-demonstration unit 100 is assisting, information about products 10, or other information related to the product demonstration. User interface 416 may receive input from the user of remote-demonstration unit 100 that may be used, for example, to control functions of remote-demonstration unit 100.

In some embodiments, image-capture device 410 includes more than one image-capture lens 413 for capturing video. For example, image-capture device 410 may include a first side 412 and a second side 414. In some embodiments, first side 412 includes a first image-capture lens 413. In some embodiments, second side 414 includes a second image-capture lens 415. First image-capture lens 413 may be used, for example, to capture video of products 10 and/or product-demonstration space 210. Second image-capture lens 415 may be used, for example, to capture video of the user of remote-demonstration unit 100. In some embodiments, image-capture device may capture and send video to a remote customer through both first and second image-capture lenses 413, 415 simultaneously. In some embodiments, image-capture device may capture and send video to a remote customer through only one of first and second image-capture lenses 413, 415 at a time. In this manner, image-capture device 410 may capture video of products 10 and the user of remote-demonstration unit 100 either simultaneously or sequentially without requiring the position of first or second image-capture lenses 413, 415 to be adjusted.

In some embodiments, when second image-capture lens 415 is used to capture video of the user of remote-demonstration unit 100, image-capture device 410 or control unit 2510, for example, may apply a blurring effect to the video that automatically blurs the background behind the user. Blurring the background may, for example, provide a move visually-pleasing image of the user and/or may provide a more consistent visual experience to customers who are connected to employees at difference customer assistance facilities. Blurring the background may also reduce distractions to the customer caused by, for example, movement in the background behind the user. In some embodiments, remote-demonstration unit 100 includes additional lighting to illuminate the user or remote-demonstration unit 100. In some embodiments, the lighting for illuminating the user or remote-demonstration unit 100 may be disposed on or coupled to, for example, top panel 220 of housing 200. In some embodiments, the lighting for illuminating the user or remote-demonstration unit 100 may be manually adjusted or may be automatically adjusted (e.g., using control unit 2510) in order to produce consistent lighting conditions despite varying ambient lighting.

In some embodiments, image-capture device 410 is disposed in device housing 420. Device housing 420 may include a first opening 422, which may provide first image-capture lens 413 with a line of sight into product-demonstration space 210. Device housing 420 may also include a second opening 424, which may provide second image-capture lens 415 with a line of sight to the user, and may also allow the user to view and interact with user interface 416. Image-capture device 410 may be inserted or removed from device housing 420 through a third opening 426 of device housing 420. In some embodiments, device housing 420 includes a spacer 428 which may help image-capture device 410 to fit securely into device housing 420 and/or to facilitate easier insertion or removal of image-capture device 410 with respect to device housing 420. In some embodiments, device housing 420 includes one or more fasteners 429 (e.g., screws, bolts, pins, or the like) that may be used to secure image-capture device 410 in device housing 420. In some embodiments, for example, fasteners 429 may be adjusted in order to press spacer 428 against image-capture device 410, thereby causing image-capture device 410 to press against device housing 420, and thereby securing image-capture device 410 in device housing 420 using a friction fit.

Attachment arm 430 may extend between a first end 432 and a second end 434 and may be used to attach device housing 420 to housing 200. In some embodiments, first end 432 of attachment arm 430 is removably coupled to housing 200 at an image-capture assembly attachment 224 on top panel 220 (see, e.g., FIG. 3). In some embodiments, attachment arm 430 includes one or more fasteners 433 (e.g., screws, bolts, pins, or the like) that may be used to couple attachment arm 430 to housing 200 at image-capture assembly attachment 224.

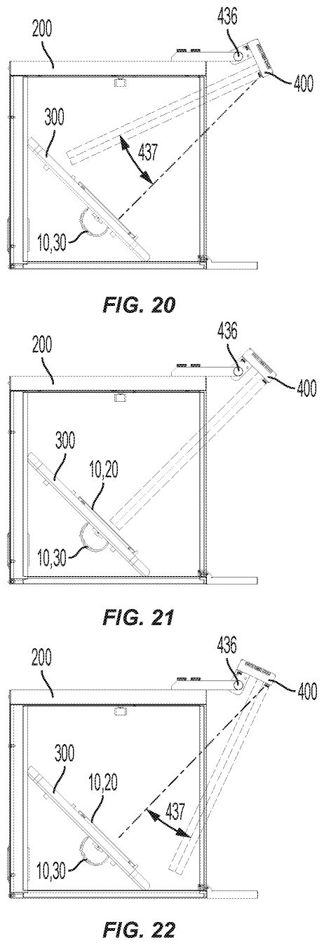

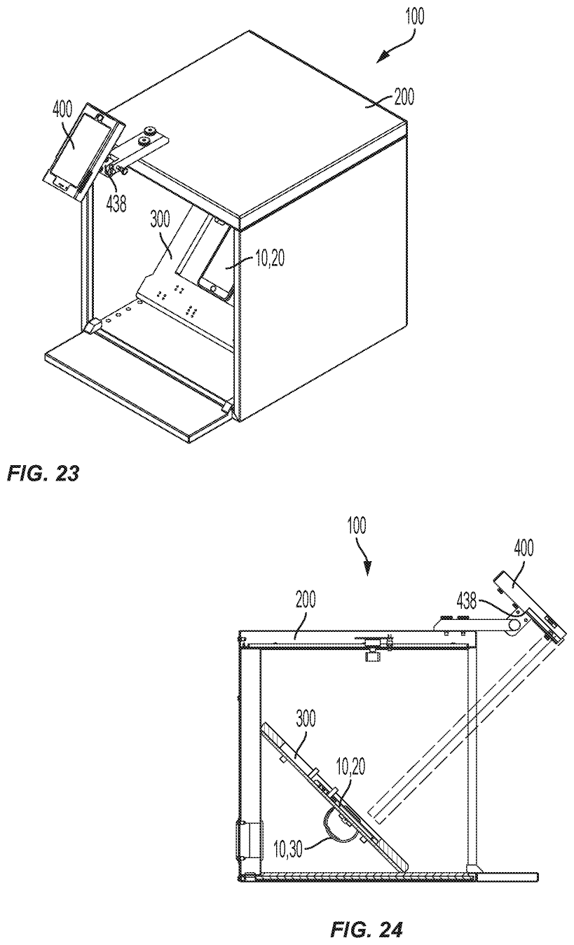

In some embodiments, second end 434 of attachment arm 430 is pivotally coupled to device housing 420. In some embodiments, attachment ann 430 includes a first pivot 436 and a second pivot 438 disposed at second end 434 of attachment arm 430. First pivot 436 may, for example, allow device housing 420 to pivot relative to attachment arm 430 in a substantially vertical plane. In this manner, the angle 437 of image-capture device 410 relative to product-display tray 300 may be adjusted using first pivot 436 (compare, e.g., FIGS. 20-22). As shown in FIG. 21, for example, image-capture device 410 may be positioned relative to product-display tray 300 such that the line of sight of first image-capture lens 413 is substantially perpendicular to product-display tray 300, which may be optimal for displaying certain type of products 10. However, the angle of image-capture device 410 relative to product-display tray 300 may be adjusted, for example, to better display other types of products 10, or to accommodate other product-display tray 300 configurations. Second pivot 436 may, for example, allow device housing 420 to pivot relative to attachment arm 430 in a plane that is substantially perpendicular to the vertical plane in which first pivot 436 permits pivoting. In this manner, device housing 420 may he, for example, rotated such that image-capture device 410 may capture video in both landscape and portrait orientations (compare FIGS. 1 and 2A with FIGS. 23 and 24).

In some embodiments, image-capture assembly 400 may include servos, motors, or the like that may be used to automatically adjust the position of device housing 420, for example, relative to attachment arm 430 and/or housing 200. Such automatic adjustment may be triggered by, for example, a user selection (e.g., through user interface 416) of a product type to be demonstrated.

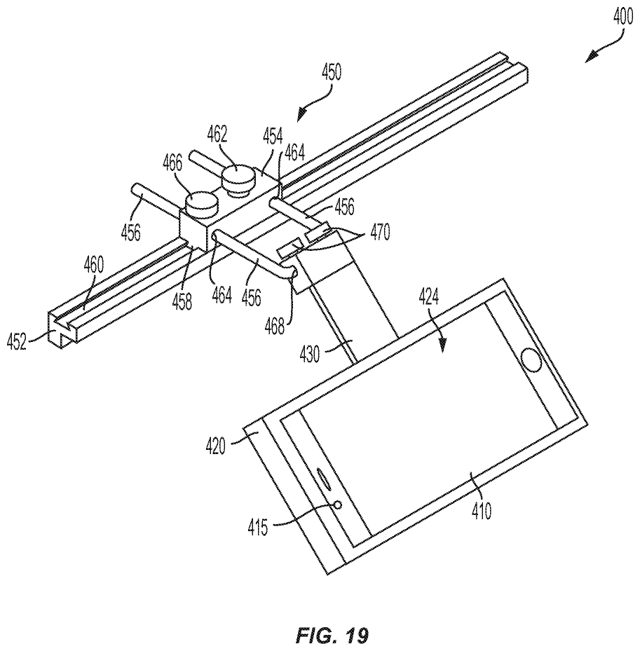

In some embodiments, image-capture assembly 400 may include a travel assembly 450, as shown, for example, in FIG. 19. Travel assembly 450 may allow the position of image-capture device 410 to be adjusted (e.g., in two linear dimensions). For example, travel assembly 450 may allow the position of image-capture device 410 to be adjusted side-to-side or front-to-back relative to housing 200. Travel assembly 450 may also allow pivoting motion of device housing 420, as described elsewhere herein.

As shown in FIG. 19, travel assembly 450 may include a track 452 extending in a first direction, a hub 454 connected to track 452 and a support bar 456 connected to hub 454. Attachment arm 430 may be coupled to support bar 456.

Travel assembly 450 may be mounted within housing 200 (e.g., ends of track 452 may be coupled to side panels 230).

Hub 454 may be constrained relative to track 452 such that hub 454 can only move linearly along track 452 (i.e., in a direction of extension of track 452). For example, hub 454 may have a protrusion 458 that fits into a groove 460 of track 452 (e.g., with corresponding shapes such that protrusion 458 cannot come out of groove 460 except at ends thereof such as a sliding dovetail configuration).

Hub 454 may include a first lock mechanism 462 to lock hub 454 in a desired position on track 452. In an unlocked configuration, first lock mechanism 462 may not interfere with movement of hub 454 along track 452. In a locked configuration, first lock mechanism 462 may prevent hub 454 from moving relative to track 452. First lock mechanism 462 may be, for example, a thumb screw, a locking lever, a clamp, etc.

Support bar 456 may be constrained relative to hub 454 such that support bar 456 can only move linearly relative to hub 454, in a direction different from the direction that hub 454 can move along track 452 (e.g., perpendicularly to the direction that hub 454 can move along track 452). For example, hub 454 may include one or more linear passageways 464. Passageways 464 may be, for example, through-holes. Support bar 456 may extend through passageways 464. Support bar 456 may be slidable within passageways 464. Passageways 464 may extend (and support bar 456 may be slidable) in a direction different from the direction of extension of track 452 (e.g., perpendicular to the direction of extension of track 452).

Hub 454 may include a second lock mechanism 466 to support bar 456 in a desired position relative to hub 454. In an unlocked configuration, second lock mechanism 466 may not interfere with movement of support bar 456 relative to hub 454. In a locked configuration, second lock mechanism 466 may prevent support bar 456 from moving relative to hub 454. Second lock mechanism 466 may be, for example, a thumb screw, a locking lever, a clamp, etc.

Attachment arm 430 may be pivotably coupled to support bar 456 (e.g., with a pivot axis extending in a direction parallel to the direction of extension of track 452). As shown in FIG. 19, instead of fasteners 433, attachment arm 430 may include a passageway 468 for receiving a portion of support bar 456. Passageway 468 and the portion of support bar 456 extending through passageway 468 may extend, for example, parallel to the direction of extension of track 452 (e.g., in a front-to-back direction). Attachment arm 430 may rotate about the portion of support bar 456 extending through passageway 468 (thereby correspond moving image-capture device 410 housed within device housing 420).

Attachment arm 430 may include a third lock mechanism 470 to support attachment arm 430 in a desired position relative to support bar 456. In an unlocked configuration, third lock mechanism 470 may not interfere with movement of attachment arm 430 relative to support bar 456. In a locked configuration, third lock mechanism 470 may prevent attachment arm 430 from moving relative to support bar 456. Third lock mechanism 470 may be, for example, a thumb screw, a locking lever, a clamp, etc.

Together, the features of travel assembly 450 allow a user to position and orient image-capture device 410 within device housing 420 in a variety of positions, providing increased freedom to frame a captured image. For example, a user may set the side-to-side position of image-capture device 410 by sliding hub 454 in the side-to-side direction along track 452, and locking hub 454 in place relative to track 452 with first lock mechanism 462 when image-capture device 410 is in the desired side-to-side position. The user may set the front-to-back position of image-capture device 410 by sliding support bar 456 in the front-to-back direction within passageways 464, and locking support bar 456 in place relative to hub 454 with second lock mechanism 466 when image-capture device 410 is in the desired front-to-back position. The user may set the angle of image-capture device 410 by rotating attachment arm 430 about support bar 456, and locking attachment arm 430 in place relative to support bar 456 with third lock mechanism 470 when image-capture device 410 is positioned at the desired angle.

In some embodiments, attachment arm 430 (and thus image-capture device 410) may be removed from housing 200. Similarly, in some embodiments, image-capture device 410 may be removed from device housing 420. As described above with respect to products 10, when not in use, image-capture assembly 400 (or image-capture device 410 alone) may be locked inside of housing 200 using lockable door 290. Accordingly, this may help to maintain control of and access to image-capture assembly 400 and its components. In some embodiments, attachment arm 430 is shown attached to housing 200 externally. However, attachment arm 430 may be attached internally in any embodiment described herein (including, for example, in embodiments where attachment arm 430 is a part of travel assembly 450 as described above).

As mentioned above, remote-demonstration unit 100 may be used to demonstrate a variety of different types of products 10. However, setting up or changing a remote-demonstration unit for different products may require manually moving parts, changing camera angle, focusing the camera, adjusting the lighting, etc. There may be significant lag time on such changeover which may diminish a customer's experience or decrease efficiency. Further, such manual adjustments may lead to inconsistency in the presentation of products, which may not be captured in a consistent, visually-appealing manner.

The ability to switch between different products 10 quickly and fluidly during a demonstration may improve a customer's experience. For example, a customer may be shopping for a new product and may wish to review and compare several different types of products. Accordingly, the user of remote-demonstration unit 100 may need to demonstrate several different kinds of products simultaneously or in relatively quick succession in order to show the customer the different product options. Similarly, the ability to switch between different products 10 quickly and fluidly between demonstrations may increase the efficiency of the system, as there may be less setup time in between customer assistance sessions that are related to different products.

In some embodiments, certain parameters of image-capture device 410, the position of image-capture device 410, and/or certain parameters of light system 270, for example, may be adjusted according to pre-set parameters such that a user may more efficiently switch between different product demonstrations while maintaining a consistent, visually-appealing presentation of products 10. For example, image-capture device 410 and/or control unit 2510 may store in their memory pre-set parameters corresponding to different types of products 10 or differently configured product-display trays 300. The pre-set parameters may include, for example, settings pertaining to the lighting, coloring, and/or visual framing of the product.

When changing from one product demonstration to another, for example, a user of remote-demonstration unit 100 may select the product's corresponding pre-set, which may trigger certain automatic adjustments to remote-demonstration unit 100. For example, image-capture device 410 may zoom (e.g., optically or digitally) to a pre-set position that properly frames the product according to the pre-set. As discussed above, the configuration of product-demonstration tray 300 promotes the repeated consistent placement of products 10, which the pre-sets can rely on in framing products 10. The desired framing of the product may also be achieved by mechanical means, for example, by automatically adjusting the position of image-capture device 410 using servos, motors, or the like. Similarly, after a pre-set is selected by a user, adjustments to the exposure and/or coloring of the video captured by image-capture device 410 may be automatically adjusted, as described in more detail below. Image-capture device 410 and/or control unit 2510 may apply also certain effects or adjustments to the video captured by image-capture device 410 according to the pre-set to maintain a consistent, visually-appealing presentation of products 10.

As mentioned above, pre-set framing may allow user 500 to quickly and easily change from one type of product demonstration to another, thereby helping to produce consistent, fluid, and visually-pleasing demonstrations of a variety of products 10. As shown in FIGS. 9A-9D, various output images 411 may be achieved by adjusting the framing of products 10 with respect to image-capture device 410. As mentioned above, image-capture device 410 may include a field of view 418 that may be, for example, the maximum observable area seen by image-capture lens 413. However, output image 411 may include images of less than field of view 418, and output image 411 may be defined by image boundary 419.

In some embodiments, image boundary 419 is rectangular in shape and may be, for example, a common video output aspect ratio (e.g., 1:1, 4:3, or 16:9). However, image boundary 419 may be any shape, and is not limited by common video output aspect ratios. In some embodiments, image boundary 419 may generally correspond to the size and shape of product 10, and may change both its size and position depending on which product 10 is being demonstrated and what aspects of it are being demonstrated. As shown in FIG. 9B, for example, output image 411 may follow an image boundary 419B that is disposed tightly around product 20. Accordingly, through product 30 is disposed at the side of product 20, only product 20 is shown in output image 411. Similarly, as shown in FIG. 9C, for example, output image 411 may follow another image boundary 419C that is disposed tightly around product 30. Accordingly, through product 20 is disposed at the side of product 30, only product 30 is shown in output image 411. However, as shown in FIG. 9D, output image 411 may also follow another image boundary 419D that is disposed around both product 20 and product 30 such that both product 20 and product 30 are shown together in the same output image 411. Further, in some embodiments, output image 411 shows only a portion of product 10. For example, as shown in FIG. 10A and 10C, output image 411 may include images of the display screen of product 10, and other portions of product 10 may be cropped from output image 411.

In some embodiments, pre-sets may be selected by an employee using, for example, user interface 416 of image-capture device 410 (see, e.g., FIG. 16). In some embodiments, image-capture device 410 and/or control unit 2510 may automatically detect which type of product or products 10 are being demonstrated and automatically select a pre-set based on the product or products 10. In some embodiments, image-capture device 410 and/or control unit 2510 may automatically detect which type of product-display tray 300 is disposed in product-demonstration space 210 and automatically select a pre-set corresponding to the configuration of the product-display tray 300. In some embodiments, products 10 or product-display tray 300 includes a machine-readable representation of data such as, for example, text having any number of characters or symbols, indicia, a linear barcode (e.g., a UPC), a matrix barcode (e.g., a QR Code), and/or a radio-frequency ID tag that is captured by image-capture device 410 and used to determine the type of product-display tray 300 disposed in product-demonstration space 210.

In some embodiments, based at least in part on a selected or otherwise activated pre-set, image-capture device 410 may automatically make adjustments to its shutter speed, aperture, or sensitivity, for example, in order to provide a consistent and accurate exposure for the video captured by image-capture device 410. Similarly, in some embodiments, based at least in part on a selected or otherwise activated pre-set, image-capture device 410 may automatically make adjustments to its white balance in order to provide consistent and accurate coloring for the video captured by image-capture device 410.

In some embodiments, to provide a consistent and accurate exposure for the video captured by image-capture device 410, control unit 2510 may automatically make adjustments to the intensity of light produced by light system 270. Control unit 2510 may, for example, receive electronic data from a light sensor in image-capture device 410 and use the electronic data to determine if the intensity of the light produced by light system 270 should be increased or decreased to maintain light intensity within a predetermined range. Similarly, in some embodiments, to provide consistent and accurate coloring for the video captured by image-capture device 410, control unit 2510 may automatically make adjustments to the color of the light produced by light system 270. Control unit 2510 may, for example, receive electronic data from a color sensor in image-capture device 410 and use the electronic data to determine if the color temperature of the light produced by light system 270 should be adjusted to maintain light color within a predetermined range.

In some embodiments, image-capture device 410 may incorporate augmented reality technology in order to enhance product demonstrations. For example, image-capture device 410 may superimpose graphics, text, or the like (e.g., arrows, dimensions, scenery, or product information) on to the video captured by image-capture device 410 in order to better show features of or convey information about products 10. In some embodiments, image-capture device 410 may use augmented reality technology to change the apparent color or surface texture of products 10, for example, such that a customer may see various product options in a quick and efficient manner.

FIG. 26 shows a block diagram of an exemplary network 2500 to which remote-demonstration unit 100 may be connected in order to remotely assist customers. Network 2500 may include remote-demonstration unit 100, control unit 2510, a firewall and session border controller (“SBC”) 2520, a network bridge 2530, a customer computer 2540, and a customer mobile device 2550.

In some embodiments, control unit 2510 is a purpose-built computer or controller that is, for example, disposed in electronics enclosure 250. In some embodiments, control unit 2510 is image-capture device 410 or is integrated into image-capture device 410. In some embodiments, control unit 2510 is an external computer, such as, for example, a desktop computer, laptop computer, server computer, or the like.

As shown in FIG. 26, control unit 2510 may send electronic data to and receive electronic data from firewall and SBC 2520. The electronic data may include, for example, network information, signaling, and media (e.g., audio, video, and text). Firewall and SBC 2520 may send and receive electronic data to network bridge 2530. Network bridge 2530 may send and receive electronic data to customer computer 2540 and/or customer mobile device 2550. In some embodiments, the SBC may encrypt and decrypt electronic data sent between remote-demonstration unit 100 and customer computer 2540 and/or customer mobile device 2550.

Customer computer 2540 may be, for example, a desktop computer, laptop computer, video game system, smartphone, tablet computer, smartwatch or the like. Customer device 2550 may also be, for example, a desktop computer, laptop computer, video game system, smartphone, tablet computer, smartwatch or the like. In some embodiments, a customer may use a web browser or web-based application on customer computer 2540 and/or customer device 2550 to connect to network 2500 in order to receive remote customer assistance. In some embodiments, customer computer 2540 and/or customer mobile device 2550 may include a purpose-built application for connecting to network 2500 in order to receive remote customer assistance. In some embodiments, customer computer 2540 and/or customer mobile device 2550 may include a videotelephony application (e.g., FaceTime® or the like) that may be used for personal commination as well to connect to network 2500 in order to receive remote customer assistance.

In order to receive customer assistance through remote-demonstration unit 100, a customer may, for example, connect to network 2500. Before initiating the remote-demonstration session, a customer may be asked to provide information such as, for example, their preferred language of communication, their reason for seeking customer assistance, the type of product or products for which they are seeking assistance, customer account information, or other related information. In some embodiments, such information may be sought and provided separately from a remote-demonstration session, for example by email or telephone. The customer may then proceed to be connected with a remote employee or, alternatively, the customer may schedule a session for a future time and date.

In some examples, before the employee is connected with the customer, the employee receives the information provided by the customer and may then set up the demonstration accordingly. For example, if the inquiry pertains to a particular product or products, the employee may set up or initialize products 10 in product-demonstration space 210 and/or adjust image-capture device 410 based on the type of products 10. Then, after the demonstration has been set up, the customer and employee may be connected.

In some examples, the customer is first greeted by a live video of the employee who is being captured through second image-capture lens 415, for example. The employee may then ask questions to the customer and/or receive feedback from the customer before proceeding to the demonstration. When the employee is ready to begin the product demonstration, the live video of the employee may transition to a live video of products 10 and/or product-demonstration space 210, which may be captured through first image-capture lens 413, for example. As discussed throughout this disclosure, the live video of products 10 and/or product-demonstration space 210 may show products 10 being demonstrated in a clean, visually-appealing environment, which may contribute to a company-branded experience for the customer. In some embodiments, more than one live video feed (e.g., from more than one of first image-capture lens 413 and second image-capture lens 415) is not sent to the customer at the same time (e.g., the customer only sees a single video, not simultaneous side-by-side or picture-in-picture videos).

In some example, after the employee has completed the product demonstration, the live video of products 10 and/or product-demonstration space 210 may transition back to the live video of the employee. Then, the employee may ask any final questions to the customer and/or receive feedback from the customer before saying goodbye and ending to the session.

In some embodiments, one remote-demonstration unit 100 may be connected to a number of different customer devices. In this manner, remote-demonstration unit 100 may be used to demonstrate products to a number of different customers simultaneously. For example, remote-demonstration unit 100 may be used as part of a remote lecture, class, seminar, or the like that may be broadcasted to a large, remote audience.

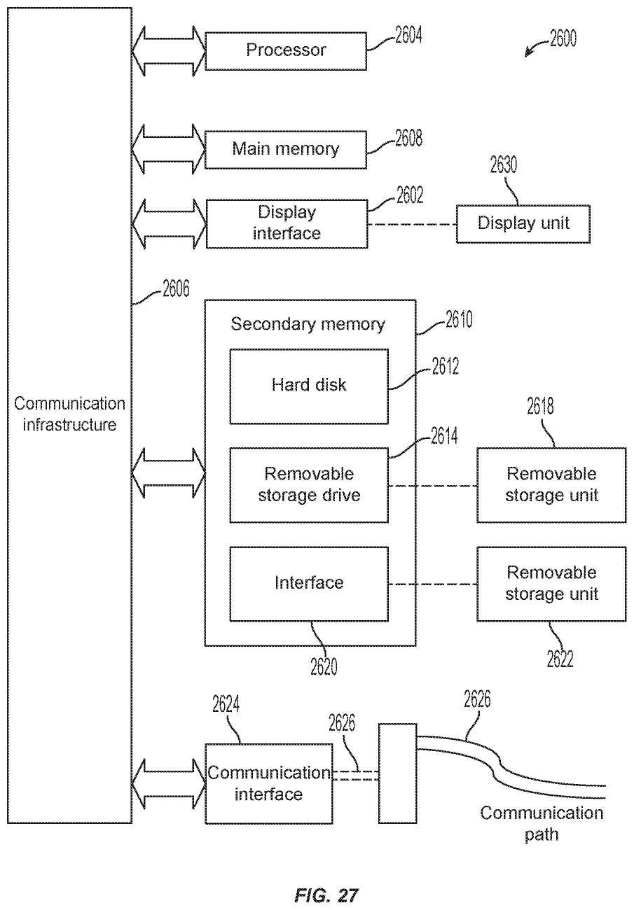

FIG. 27 illustrates an exemplary computer system 2600 in which embodiments, or portions thereof, may be implemented as computer-readable code. For example, processing of user 500 inputs and/or control of certain remote-demonstration unit 100 operations (lighting adjustments, image capturing, network connectivity, etc.) may be implemented in computer system 2600 using hardware, software, firmware, tangible computer readable media having instructions stored thereon, or a combination thereof and may be implemented in one or more computer systems or other processing systems. Control units 2510 discussed herein may be computer systems having all or some of the components of computer system 2600 for implementing processes discussed herein.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments may be implemented in terms of this example computer system 2600. After reading this description, it will become apparent to a person skilled in the relevant art how to implement one or more of the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 2604 may be a special purpose or a general purpose processor device. As will be appreciated by persons skilled in the relevant art, processor device 2604 may also be a single processor in a multi-core/multiprocessor system, such system operating alone, or in a cluster of computing devices operating in a cluster or server farm. Processor device 2604 is connected to a communication infrastructure 2606, for example, a bus, message queue, network, or multi-core message-passing scheme,

Computer system 2600 also includes a main memory 2608, for example, random access memory (RAM), and may also include a secondary memory 2610. Secondary memory 2610 may include, for example, a hard disk drive 2612, or removable storage drive 2614. Removable storage drive 2614 may include a floppy disk drive, a magnetic tape drive, an optical disk drive, a flash memory, or the like. The removable storage drive 2614 reads from and/or writes to a removable storage unit 2618 in a well-known manner. Removable storage unit 2618 may include a floppy disk, magnetic tape, optical disk, a universal serial bus (USB) drive, etc. which is read by and written to by removable storage drive 2614. As will be appreciated by persons skilled in the relevant art, removable storage unit 2618 includes a computer usable storage medium having stored therein computer software and/or data.

Computer system 2600 (optionally) includes a display interface 2602 (which can include input and output devices such as keyboards, mice, etc.) that forwards graphics, text, and other data from communication infrastructure 2606 (or from a frame buffer not shown) for display on display unit 2630. In some embodiments, display interface 2602 is user interface 416.

In alternative implementations, secondary memory 2610 may include other similar means for allowing computer programs or other instructions to be loaded into computer system 2600. Such means may include, for example, a removable storage unit 2622 and an interface 2620. Examples of such means may include a program cartridge and cartridge interface (such as that found in video game devices), a removable memory chip (such as an EPROM, or PROM) and associated socket, and other removable storage units 2622 and interfaces 2620 which allow software and data to be transferred from the removable storage unit 2622 to computer system 2600.

Computer system 2600 may also include a communication interface 2624. Communication interface 2624 allows software and data to be transferred between computer system 2600 and external devices. Communication interface 2624 may include a modem, a network interface (such as an Ethernet card), a communication port, a PCMCIA slot and card, or the like. Software and data transferred via communication interface 2624 may be in the form of signals, which may be electronic, electromagnetic, optical, or other signals capable of being received by communication interface 2624. These signals may be provided to communication interface 2624 via a communication path 2626. Communication path 2626 carries signals and may be implemented using wire or cable, fiber optics, a phone line, a cellular phone link, an RF link or other communication channels.

In this document, the terms “memory” is used to generally refer to media such as removable storage unit 2618, removable storage unit 2622, and a hard disk installed in hard disk drive 2612. “Memory” may also refer to memories such as main memory 2608 and secondary memory 2610, which may be memory semiconductors (e.g. DRAMs, etc.).

Computer programs (also called computer control logic) are stored in main memory 2608 and/or secondary memory 2610. Computer programs may also be received via communication interface 2624. Such computer programs, when executed, enable computer system 2600 to implement the embodiments as discussed herein. In particular, the computer programs, when executed, enable processor device 2604 to implement the processes of the embodiments discussed here. Accordingly, such computer programs represent controllers of the computer system 2600. Where the embodiments are implemented using software, the software may be stored in a computer program product and loaded into computer system 2600 using removable storage drive 2614, interface 2620, and hard disk drive 2612, or communication interface 2624.

Embodiments also may be directed to computer program products comprising software stored on any computer useable medium. Such software, when executed in one or more data processing device, causes a data processing device(s) to operate as described herein. Embodiments of the may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A remote-demonstration unit, comprising:
a housing defining a product-demonstration space;
a product-display tray disposed within the product-demonstration space at an oblique angle relative to a bottom of the housing;
a light system for illuminating the product-demonstration space; and
an image-capture device coupled to the housing and having an image-capture lens directed toward the product-demonstration space,
wherein the product-display tray comprises product-support features for supporting products on the product-display tray in different spaced-apart layers.

2. The remote-demonstration unit of claim 1, wherein the product-support features comprise a recess for supporting a first type of product, and
wherein the product-support features comprise a support peg disposed within the recess, for supporting a second type of product over the recess.

3. The remote-demonstration unit of claim I, wherein the product-support features comprise a recess defining a first support surface,
wherein the product-support features comprise a lower pedestal raised relative to the first support surface and defining a second support surface, and
wherein the product-support features comprise a support peg disposed within the recess and extending up from the first support surface.

4. The remote-demonstration unit of claim 3, wherein the product-support features comprise a stop extending from the second support surface, configured to support a product in position on the product-display tray.

5. The remote-demonstration unit of claim 4, wherein the stop is removable and repositionable on the second support surface.

6. The remote-demonstration unit of claim 3, wherein an upper surface of the support peg is raised relative to the first support surface at least as far as the lower pedestal is raised relative to the first support surface.

7. The remote-demonstration unit of claim 3, wherein the lower pedestal is part of a frame surrounding the recess.

8. The remote-demonstration unit of claim 1, wherein the product-display tray comprises at least one concealed connector for providing power to a displayed product.

9. A remote-demonstration system, comprising the remote-demonstration unit of claim 1, and comprising a second product-display tray configured to be disposed within the product-demonstration space, wherein the second product-display tray has product-support features in a different configuration from the first product-display tray, and wherein the first product-display tray is configured to be removed and replaced by the second product-display tray.

10. The remote-demonstration unit of claim 1, wherein the light system comprises light-emissive panels disposed at the sides of and beneath the product-display tray, wherein light produced by the light-emissive panels passes through, is diffused by, and illuminates the product-display tray.

11. The remote-demonstration unit of claim 1, wherein the remote-demonstration unit is a desktop unit, with a footprint area of less than 4 square feet.

12. A remote-demonstration unit, comprising:
a housing defining a product-demonstration space;
a translucent product-display tray disposed within the product-demonstration space for displaying products;
an image-capture device for capturing video of displayed products; and
light-emissive panels disposed at the sides of and beneath the product-display tray, wherein light produced by the light-emissive panels passes through, is diffused by, and illuminates the product-display tray.

13. The remote-demonstration unit of claim 12. wherein the product-display tray is white, and wherein the light that passes through, is diffused by, and illuminates the product-display tray provides a uniform white appearance for capture by the image-capture device without shadows from a displayed device being captured by the image-capture device.

14. The remote-demonstration unit of claim 12, wherein the intensity and color of light produced by the light-emissive panels are configured to automatically adjust to compensate for ambient light.

15. The remote-demonstration unit of claim 12, wherein a control unit receives electronic data from a light sensor of the image-capture device, and wherein the control unit automatically adjusts the intensity and color of light produced by the light-emissive panels based on the electronic data received from the light sensor.

16. A remote-demonstration system, comprising the remote-demonstration unit of claim 12, wherein the product-display tray is configured to be removed and replaced with a product-display tray of a different type, having different product-display characteristics, and
wherein the light-emissive panels are configured to adjust to a plurality of pre-set parameters for intensity and color of light produced, based on the type of product-display tray disposed within the product-demonstration space.

17. The remote-demonstration unit of claim 12, wherein the housing comprises a top panel disposed above the product-display tray, and wherein an interior surface of the top panel is matte black.

18. A remote-demonstration system, comprising:
a housing defining a product-demonstration space;
a product-display tray disposed within the product-demonstration space;
a consumer electronic device disposed on the product-display tray;
a light system configured to illuminate the product-display tray and the consumer electronic device; and
an image-capture device comprising an image-capture lens configured to capture video of a user's manipulation of the consumer electronic device,
wherein the video captured by the image-capture device is sent in real time to a remote customer device over a network, and
wherein the consumer electronic device is disposed in a pre-defined position on the product-display tray, and wherein framing of the video captured by the image-capture device is adjusted to pre-defined extents based on the device type of the consumer electronic device.

19. The remote-demonstration system of claim 18, wherein the image-capture device comprises a second image-capture lens directed away from the product-demonstration space for capturing video of the user of the remote-demonstration system.

20. The remote-demonstration system of claim 19, wherein a background blurring effect is automatically applied to video captured through the second image-capture lens.

21. The remote-demonstration system of claim 19, wherein the image-capture device is configured to send video to the remote customer device from only one of the first image-capture lens and the second image-capture lens at a time.

22. The remote-demonstration system of claim 18, comprising a second consumer electronic device disposed on the product-display tray, wherein the video captured by the image-capture device shows both the first consumer electronic device and the second consumer electronic device simultaneously.

23. The remote-demonstration system of claim 22, wherein a manipulation of the first consumer electronic device by the user of the remote-demonstration system causes a visible response from the second displayed product without direct manipulation of the second consumer electronic device by the user of the remote-demonstration unit.

24. The remote-demonstration system of claim 18, wherein the image-capture device is a smartphone, and wherein adjustments to the framing of the video captured by the image-capture device are triggered by an application on the smartphone.

25. The remote-demonstration system of claim 18, wherein the adjustment to the framing of the video captured by the image-capture device does not involve repositioning of the image-capture lens.

26. The remote-demonstration system of claim 18, further comprising a microphone, wherein audio captured by the microphone is sent in real time to the remote customer device over the network simultaneously with the video.
